(19) United States
(12) Patent Application Publication
(10) Pub. No.: US 2010/0047529 A1
(43) Pub. Date: Feb. 25, 2010

(54) Protected Glass Article And Method

(76) Inventor: Steven R. Meizlish, Columbus, OH (US)

Correspondence Address: WOOD, HERRON & EVANS, LLP, 2700 CAREW TOWER, 441 VINE STREET, CINCINNATI, OH, 45202, US

(21) Appl. No.: 12/338,454

(22) Filed: Dec. 18, 2008

Related U.S. Application Data
(60) Provisional application No. 61/090,100, filed on Aug. 19, 2008.

(51) Int. Cl. B32B 17/00; B32B 37/12; B32B 38/00

(52) U.S. Cl. 428/192; 156/212

(57) ABSTRACT

A protected glass article includes a glass panel having a first side, a second side opposite the first side, and a peripheral edge. An adhesive tape is applied along the peripheral edge of the glass panel and extends over the first and second sides of the glass panel. The adhesive tape includes an elongate strip of web material having adhesive disposed only on selected portions of one side of the web material to define adhesive areas and adhesive-free areas on the web material.

### CROSS-REFERENCE

This application claims priority to pending U.S. Provisional Patent Application No. 61/090,100, filed Aug. 19, 2008 (pending), which is incorporated by reference herein in its entirety.

### TECHNICAL FIELD

The present invention relates generally to glass articles, and more particularly to a glass panel having a protective adhesive tape applied around a peripheral edge.

### BACKGROUND OF THE INVENTION

Various glass panels, such as windshields, mirrors, windows, and doors, are typically stored in a vertical arrangement until needed for installation in an appropriate structure. These glass panels are susceptible to being scratched, chipped, or otherwise physically damaged, especially along their peripheral edges, during storage and movement of the glass panels from storage to an installation site. Such physical damage detracts from the aesthetic appearance of the glass panels and may ultimately result in the return of the damaged glass panels for rework or scrap. Such returned glass panels result in wasted time and money and is an inconvenience to end purchasers who must generally delay installation until a new glass panel is reordered to replace the damaged glass panel. A need therefore exists for apparatus and methods for protecting glass panels from scratching, chipping, and other physical damage.

### DESCRIPTION OF FIGURES

FIG. 1 is a perspective view of a portion of a glass panel including an exemplary adhesive tape in accordance with the present disclosure.

FIG. 2 is a perspective view of another embodiment of a glass panel and the exemplary adhesive tape of FIG. 1.

FIG. 3 is a plan view of the exemplary tape of FIGS. 1 and 2.

FIG. 4 is a plan view of a second embodiment of an adhesive tape in accordance with the present disclosure.

FIG. 5 is a plan view of a third embodiment of an adhesive tape in accordance with the present disclosure.

FIG. 6 is a plan view of a fourth embodiment of an adhesive tape in accordance with the present disclosure.

### DETAILED DESCRIPTION

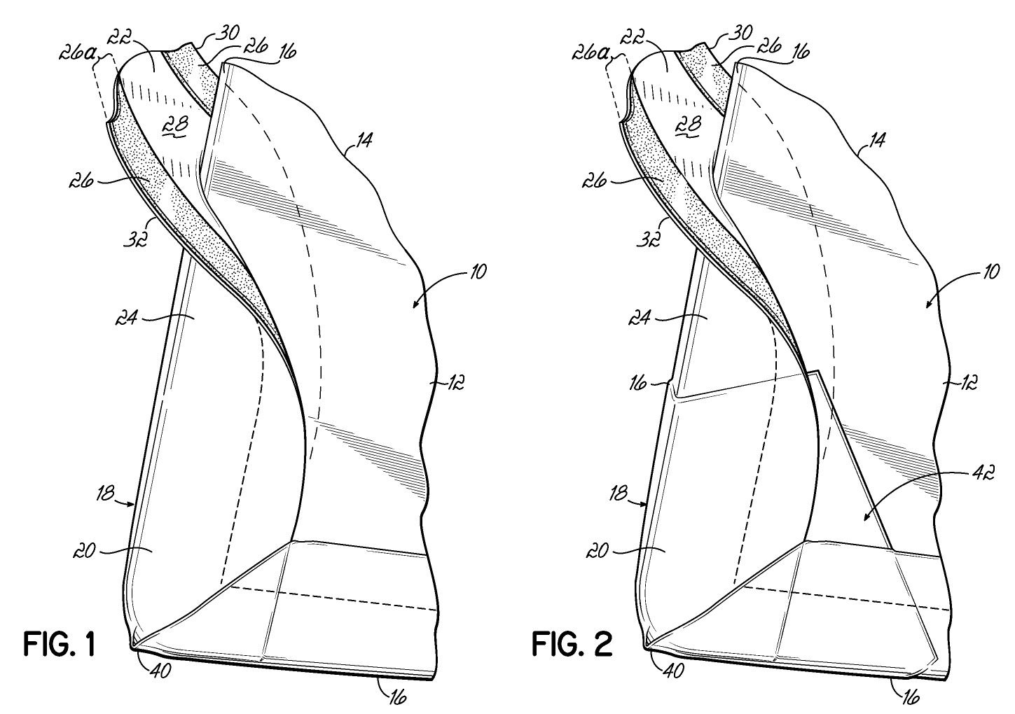

FIG. 1 depicts a glass panel 10, such as a windshield, having a first side 12, a second side 14 opposite the first side 12, and a peripheral edge 16. An exemplary adhesive tape 18 in accordance with the present disclosure is disposed along the peripheral edge 16 of the glass panel 10. The adhesive tape 18 comprises an elongate strip of web material 20 having a first side 22 and a second side 24. Adhesive 26 is disposed only on selected areas of the first side 22 of the web material 20 to define adhesive areas 26a and adhesive free areas 28 on the first side 22. The first side 22 of the web material 20 faces the glass panel 10 and is folded along the peripheral edge 16 of the glass panel 18 such that the adhesive 26 contacts the first and second sides 12, 14 of the glass panel 10.

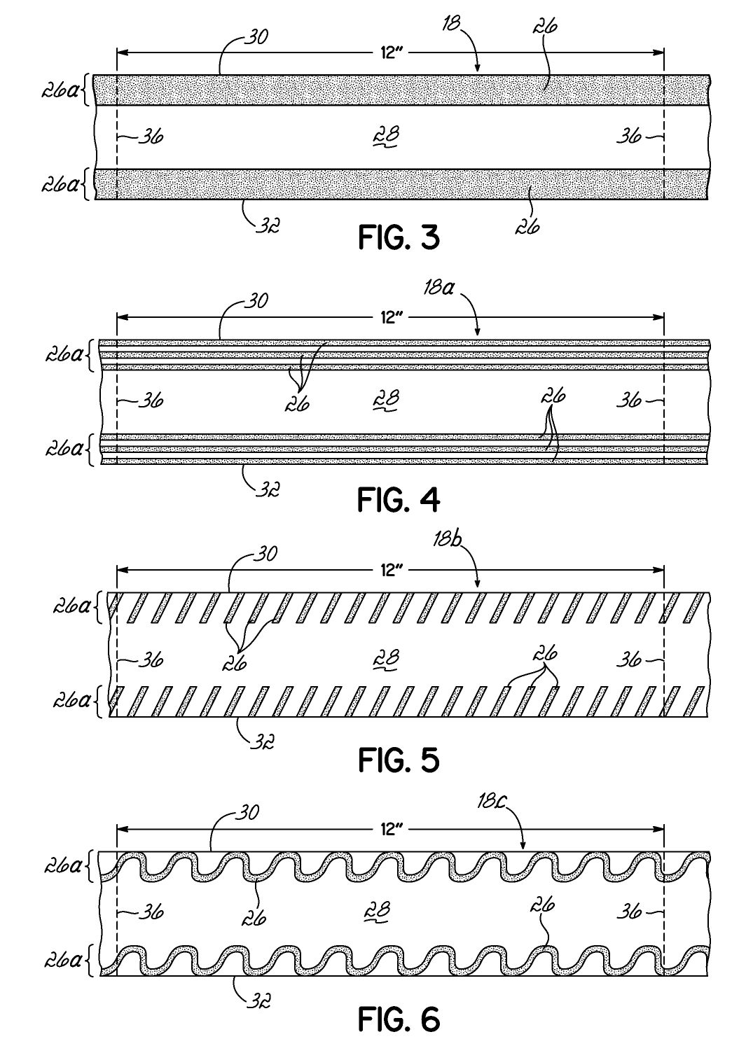

With continued reference to FIG. 1, and referring further to FIG. 3, the adhesive tape 18 in this embodiment includes adhesive 26 disposed at spaced intervals across a width of the web material 20 to define alternating bands of adhesive and adhesive free areas 26a, 28 across the width of the web material 20. In the embodiment shown, adhesive 26 is applied along the side edges 30, 32 of the web material 20, and a central portion 34 of the web material 20 defines an adhesive free area 28. The adhesive tape 18 may further include perforations 36 formed transversely across the web material 20 to facilitate tearing portions of the web material 20 from longer lengths of the web material 20. While perforations are shown and described herein, it will be appreciated that scores, weakened portions, or various other structure suitable to facilitate tearing portions of the web material 20 may alternatively be used. Alternatively, the web material 20 may be formed from material, such as uniaxially-oriented film material, to facilitate tearing portions of the web material 20 from longer lengths of the web material 20.

To apply the adhesive tape 18 of FIG. 3 to the glass panel 10, the adhesive tape 18 is extended lengthwise along the side edge 16 of the glass panel 10 such that the adhesive-free central portion 34 of the tape 18 contacts the peripheral edge 16 of the glass panel 10. The side edges 30, 32 of the adhesive tape 18 are then deformed downwardly such that the adhesive 26 contacts and adheres to the first and second sides 12, 14 of the glass panel 10. In the embodiment shown in FIG. 1, the adhesive tape 18 may be folded proximate a corner 40 of the glass panel 10 such that a continuous length of the adhesive tape 18 may be extended around the entire peripheral edge 16 of the glass panel 10. When the side edges 30, 32 of the adhesive tape 18 are thereafter folded over to contact the first and second sides 12, 14 of the glass panel 10, overlapping portions of the adhesive tape 18 are created to define a region of multiple layers of the adhesive tape that may provide additional protection to the corner 40 of the glass panel 10.

FIG. 2 depicts another embodiment of a glass panel 10 protected with adhesive tape 18 in accordance with the present disclosure. In this embodiment, an additional corner tape 42 is applied to the corner 40 of the glass panel 10, prior to application of the adhesive tape 10, as described above. The additional corner tape 42 provides increased protection of the corner 40 of the glass panel 10. While this embodiment has been shown and described as having an additional corner tape 42 applied to the glass panel 10 beneath the adhesive tape 18, it will be appreciated that the corner tape 42 may alternatively be applied over top of the adhesive tape 18. It will also be appreciated that the adhesive tape 18 may alternatively be applied as individual strips to the peripheral edge 16 of the glass panel 10, as opposed to one long, continuous strip that is folded around the corners 40 of the glass panel 10.

While the adhesive tape 18 has been shown and described in FIGS. 1-3 as comprising bands of adhesive 26 applied along the side edges 30, 32 of the web material 20, it will be appreciated that various other configurations of adhesive 26 may be applied to the first side 22 of the web material 20, as may be desired. FIGS. 4-6 illustrate additional, non-limiting exemplary embodiments of adhesive tape 18a, 18b, 18c that may be applied to the peripheral edge 16 of a glass panel 10 in a manner similar to that described above. In each of these exemplary embodiments, features that are similar to the features discussed above with respect to FIGS. 1-3 have been similarly numbered.

While various aspects in accordance with the principles of the invention have been illustrated by the description of various embodiments, and while the embodiments have been described in considerable detail, they are not intended to restrict or in any way limit the scope of the invention to such detail. The various features shown and described herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope of the general inventive concept.

What is claimed is:

1. A protected glass article, comprising:
a glass panel having a first side, a second side opposite said first side, and a peripheral edge; and
an adhesive tape disposed along said peripheral edge of said glass panel and extending over said first side and said second side;
said adhesive tape comprising:
an elongate strip of web material having a first side and a second side, and
adhesive disposed only on selected areas of said first side of said web material to define adhesive areas and adhesive-free areas on said first side.

2. The protected glass article of claim 1, wherein said adhesive tape is folded over itself along a corner of said glass panel to define a region of multiple layers of said adhesive tape.

3. The protected glass article of claim 1, further comprising at least a second adhesive tape applied at least proximate a corner of said glass panel.

4. The protected glass article of claim 1, wherein said adhesive is disposed at spaced intervals across a width of said web material to define alternating bands of adhesive and adhesive-free areas across said web material.

5. The protected glass article of claim 1, wherein a central portion of said web material across a width of said web material is free from adhesive.

6. The protected glass article of claim 1, wherein said adhesive is adapted such that when said adhesive tape is removed from said glass panel, no residue is left on said glass panel from said adhesive tape.

7. The protected glass article of claim 1, wherein said web material comprises polymeric film.

8. The protected glass article of claim 7, wherein said polymeric film comprises low-density polyethylene.

9. The protected glass article of claim 1, further comprising perforations formed through said web material to facilitate tearing said web material.

10. The protected glass article of claim 1, wherein said adhesive areas on said web material comprise no more than ⅔ of the surface area of said first side of said web material.

11. The protected glass article of claim 1, wherein said adhesive areas on said web material comprise no more than half of the surface area of said first side of said web material.

12. The protected glass article of claim 1, wherein said adhesive tape is colored to improve visibility of said adhesive tape.

13. A method of protecting a glass panel, comprising:
obtaining an adhesive tape having a first side and a second side, the first side of the tape including adhesive disposed only on selected areas of the first side to define adhesive areas and adhesive-free areas on the first side;
applying the adhesive tape along a side edge of the glass panel; and
deforming the adhesive tape such that the first side of the adhesive tape contacts the first and second oppositely disposed sides of the glass panel.
